(19) United States
(12) Patent Application Publication
(10) Pub. No.: US 2025/0123476 A1
(43) Pub. Date: Apr. 17, 2025

(54) Microscope Enabled 3D Bioprinting System

(71) Applicant: Wisconson Alumni Research Foundation, Madison, WI (US)

(72) Inventors: Alexander McGhee, Madison, WI (US); Christian Franck, Madison, WI (US)

(21) Appl. No.: 18/379,435

(22) Filed: Oct. 12, 2023

(51) Int. Cl. G02B 21/32; B33Y 10/00; B33Y 30/00; G02B 21/00

(52) U.S. Cl. CPC G02B 21/32; B33Y 10/00; B33Y 30/00; G02B 21/0016; G02B 21/0088

(57) ABSTRACT

An apparatus controls a series of actuators mounted onto inverted microscope assemblies to add 3D bioprinting and pick and place capabilities on a microscopic scale. One or more syringes are also mounted to the apparatus and the plunger of each syringe is independently actuated to extrude or extract fluids from the optically aligned needle. A software package communicates with the microscope x, y stage as well as the on-board motor controller which actuates the syringes and needle to set the x, y, z position and syringe in real time.

### STATEMENT REGARDING FEDERALLY SPONSORED RESEARCH OR DEVELOPMENT

[symbol]

### CROSS REFERENCE TO RELATED APPLICATION

[symbol]

### BACKGROUND OF THE INVENTION

The present invention relates to an apparatus for picking, placing, collecting and arranging objects at microscopic scale and, in particular, to an improved apparatus for performing such operations using an inverted microscope.

The ability to pick, place, collect and arrange microscopic objects such as cells for experiments requiring pick and place (e.g., chip platforms, gradient studies, etc.), 3D bioprinting, and micromanipulation processes, has considerable value in medical and biological research.

In one example, pick and place systems may be used to transfer microscopic targets such as single cells from one position to another position by viewing the cells through a microscope. The system may use a small micropump such as an electroosmotic pump connected to a micropipette to control the hold, suction, and discharge of small volumes (in the order of picolitres) of fluid holding the single cells.

In another example, 3D bioprinting or live cell bioprinting systems may be used to fabricate complex biological constructs in the field of tissue engineering and regenerative medicine. The system may provide precise and controlled layer by layer assembly of cells in a specific arrangement that utilizes similar techniques used in pick and place systems where cells or tissues are loaded into micropipettes and then discharged into printing molds to build the tissue from the bottom up.

In another example, micromanipulation systems may be used in the semiconductor industry, genetic engineering, in vitro fertilization, cell biology, and virology to make precise movements (in the order of microns) to the object being manipulated. The system may use a micromanipulator or microinjector, along with micropipettes, electrodes or probes under a microscope to, for example, inject a substance into a single cell to genetically modify the cell.

Prior techniques used in research settings use pick and place, 3D bioprinting, and micromanipulation systems, which are cost prohibitive and space consuming. Generally, these systems require specialized equipment including stands, platforms, controllers, micromanipulators or microinjectors, and micropipettes. Standalone devices may incorporate customized joystick micro-manipulators with customized inverted microscopes for observing and positioning microscopic objects at target locations but which add a high expense to the system.

### SUMMARY OF THE INVENTION

The present invention provides an apparatus that controls a series of actuators mounted onto a conventional inverted microscope assembly to add pick and place and 3D bioprinting capabilities at a microscopic scale. This invention takes advantage of a mounting bracket common to most if not all inverted microscopes to optically align a needle using a light source of the device and the microscope's lens to control the needle's axial position. One or more syringes are also mounted to the device and the plunger of each syringe is independently actuated to extrude or extract fluids from the optically aligned needle. Finally, conventional inverted microscopes utilize a motorized x, y stage with nano positioning capabilities. A software package communicates with the microscope x, y stage as well as the on-board motor controller which actuates the syringes and sets the x, y, z position of the needle in real time. Control software may enable automated manipulation of cell culture systems with the incorporation of machine learning and artificial intelligence techniques.

In one embodiment of the present invention, the present invention integrates with existing common lab infrastructure to enable a large suite of capabilities that would either be cost prohibitive or too niche as separate standalone devices.

In one embodiment of the present invention, the present invention controls the gas flow and temperature within an incubation chamber which accompanies the 3D bioprinting operations.

One embodiment of the present invention provides an apparatus for manipulating microscopic objects with an inverted microscope having a stage positioned above an objective lens for supporting the microscopic objects, comprising: a housing having at least one support adapted to attach to the inverted microscope; a needle holder attachable to the housing permitting a needle to move along at least one axis; an orifice extending through the housing permitting the needle to move therethrough and position the needle above the stage and objective lens of the inverted microscope; and a pump assembly attachable to the housing and operating to communicate with the needle to permit fluid flow through the needle.

It is thus a feature of at least one embodiment of the present invention to adapt commercially available inverted microscopes for microscopic pick and place operations by adapting universal inverted microscope structures for use with the device of the present invention.

At least one support may be adapted to attach to a condenser mount of the inverted microscope and configured to suspend the housing above the stage.

It is thus a feature of at least one embodiment of the present invention to use upstanding support structure of the inverted microscopes to permit suspension of the device housing above the stage to utilize the translating stage and objective lens of the microscope.

At least one support may be an upwardly extending removable disk receivable by the condenser mount to permit the condenser mount to hold the removable disk.

It is thus a feature of at least one embodiment of the present invention to allow the device to be adaptable for use with most commercially available inverted microscopes.

A light source may be attachable to the housing and configured to direct light below of the housing and toward the stage.

It is thus a feature of at least one embodiment of the present invention to reposition the preexisting light source of conventional inverted microscopes to a position below the device in order for the microscopic objects to be seen clearly through the objective lens below the stage.

A light diffuser may surround the orifice and be positioned below the light source.

It is thus a feature of at least one embodiment of the present invention to provide sufficient LED lighting to the microscopic objects and which may use the power source of the controller.

The pump assembly may comprise at least one syringe pump having a motor unit attachable to the housing and including an electrical motor and driver to move a plunger of the syringe and connectable to fluidic tubing fluidly communicating with the needle.

It is thus a feature of at least one embodiment of the present invention to permit small, controlled amounts of fluid to be suctioned, held, and discharged by the device needle.

A controller may execute a program stored in memory and communicate with the electrical motor of the pump assembly to control the movement of the plunger based on a command signal.

It is thus a feature of at least one embodiment of the present invention to permit user operation of the pump assembly through, for example, a wireless controller in real time.

The pump assembly may comprise at least three syringe pumps.

It is thus a feature of at least one embodiment of the present invention to allow the device to be used with a broad range of anticipated pick and place applications using an anticipated volume of fluid.

The pump assembly may comprise a removable cradle attachable to the housing receiving at least one syringe tube of the at least one syringe pumps.

It is thus a feature of at least one embodiment of the present invention to allow the syringe driver to be usable with various syringe barrel sizes and easily loadable into the device.

A tube collector may be attachable to the housing and providing parallel channels receiving the fluidic tubing.

It is thus a feature of at least one embodiment of the present invention to provide line organization which minimizes tangling or tension on the fluidic tubing as the connected needle actuates up and down.

The needle holder may comprise a motor unit attachable to the housing and including an electrical motor and driver to move a needle mounting bracket along the axis based on a command signal.

It is thus a feature of at least one embodiment of the present invention to actuate movement of the pick and place needle using a motor permitting small, controlled movements.

A controller may execute a program stored in memory and communicate with the electrical motor of the needle holder to control the movement of the needle mounting bracket based on a command signal.

It is thus a feature of at least one embodiment of the present invention to allow needle position and stage position to be operated by a user using a wireless controller in real time.

The needle holder may comprise a tube collar coupled to the needle mounting bracket and configured to retain the needle therein.

It is thus a feature of at least one embodiment of the present invention to allow the tube collar to receive various sizes of needles.

The tube collar may be slidable along the axis with respect to the needle mounting bracket and independent of movement of the needle mounting bracket.

It is thus a feature of at least one embodiment of the present invention to protect the needle from breakage by permitting the needle to slide upward away from the stage when sufficient upward force is applied to the needle tip.

A method of manipulating microscopic objects with an inverted microscope having a stage positioned above an objective lens for supporting the microscopic objects, comprising: providing a housing having at least one support adapted to attach to the inverted microscope, a needle holder attachable to the housing permitting a needle to move along at least one axis, an orifice extending through the housing and permitting the needle to move therethrough, and a pump assembly attachable to the housing and operating to communicate with the needle to permit fluid flow through the needle; attaching the at least one support of the housing to an inverted microscope to suspend the housing above the stage; installing a needle within the needle holder; moving the needle holder and needle along the axis to extend the needle through the orifice; and manipulating microscopic objects supported on the stage via fluid flow through the needle.

The method may comprise directing light toward the stage.

It is thus a feature of at least one embodiment of the present invention to modify the inverted microscope for use with the device by repositioning the microscope lighting to the bottom of the device.

The method may comprise controlling movement of the plunger based on a command signal. The method may comprise controlling movement of the needle mounting bracket along the axis based on a command signal.

It is thus a feature of at least one embodiment of the present invention to provide needle flow and needle position operations to a standalone device operable with stage position and magnification capabilities of an inverted microscope.

These particular objects and advantages may apply to only some embodiments falling within the claims and thus do not define the scope of the invention.

### BRIEF DESCRIPTION OF THE DRAWINGS

FIG. 1 is perspective view of an inverse microscope used with a device used for microscopic pick and place operations according to one embodiment of the present invention as may be attached to a condenser mount (with the condenser removed) of the conventional inverse microscope;

FIG. 2 is an exploded view of the device shown in FIG. 1 with a rear wall removed showing a rear compartment holding a removable pump assembly supporting three syringes held by a mount for communication with a syringe driver for pumping fluid through connected fluidic tubing;

FIG. 3 is a fragmentary view of the device shown in FIG. 1 with a front wall removed and left sidewall partially removed showing a front compartment holding a needle assembly supporting a needle held by a mount for communication with a needle driver for moving a needle upward and downward and the left sidewall supporting a control panel;

FIG. 4 is an enlarged view of the needle assembly shown in FIG. 3 with a needle mount holding a needle and slidably movable upward with respect to a rail mount and the rail mount movable upward and downward with the needle driver;

FIG. 5 is an incubator usable with the device of FIG. 1 positionable on the stage of the inverted microscope and below the device of the present invention whereby the incubator provides a housing for supporting a petri dish or glass slide holding microscopic objects such as cell cultures for pick and place; and

FIG. 6 is an exploded, cross sectional view of the incubator of FIG. 5 showing the housing receiving a lip of an inner, removable chamber for supporting the petri dish or glass slide therein.

### DETAILED DESCRIPTION OF THE PREFERRED EMBODIMENT

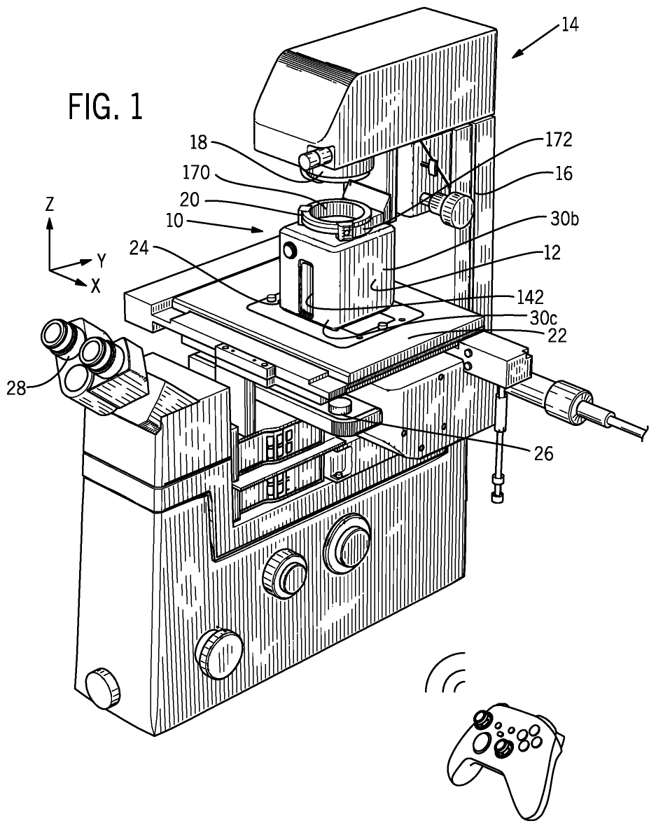

Referring now to FIG. 1, a pick and place device 10 constructed according to one embodiment of the present invention may provide a housing 12 that is attachable to an inverted microscope 14. The pick and place device 10 permits the transfer of microscopic targets for pick and place and 3D bioprinting operations at a microscopic scale.

The inverted microscope 14 used in connection with the pick and place device 10 may be a conventional inverted microscope 14 (e.g., Nikon Eclipse Ti2) having an arm 16 supporting a light source 18 extending over a condenser held by a condenser mount 20. The arm 16 supports the light source 18 and condenser mount 20 over a translating stage 22 supporting microscopic objects 24 for viewing and observing microscopic objects through an objective lens 26 below the translating stage 22 pointing upwards by looking through an eyepiece 28, and as understood in the art.

The housing 12 is sized and shaped to be supported by and beneath the condenser mount 20 of the inverted microscope 14 and is held above the translating stage 22 to permit the user to observe microscopic objects 24 held below the housing 12 but on the translating stage 22 of the inverted microscope 14. The microscopic objects 24 are viewable through the eyepiece 28. The housing 12 holds several elements therein which assist with pick and place, 3D bioprinting (i.e., live cell printing), and micromanipulation of the microscopic objects 24 as further described herein.

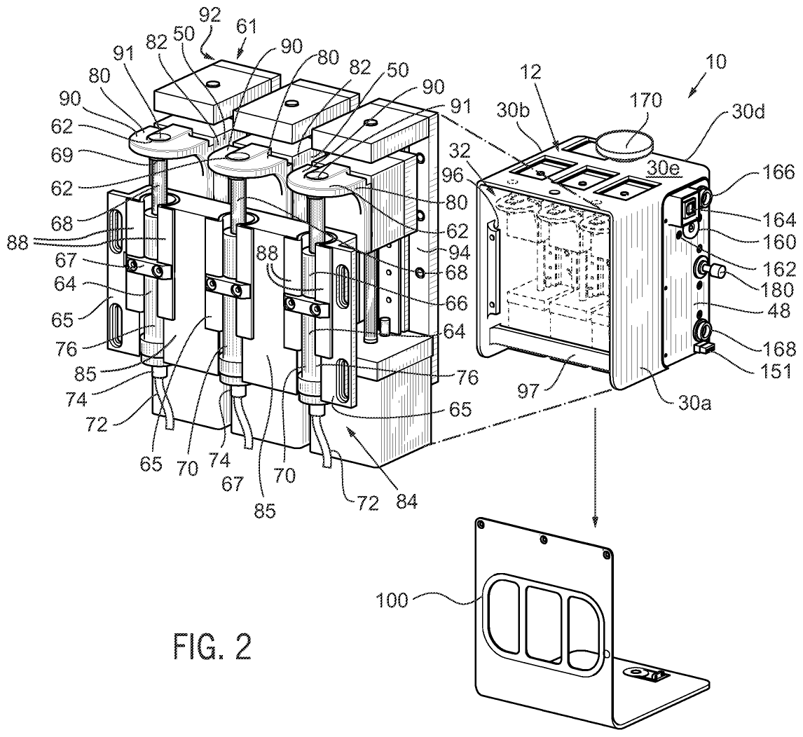

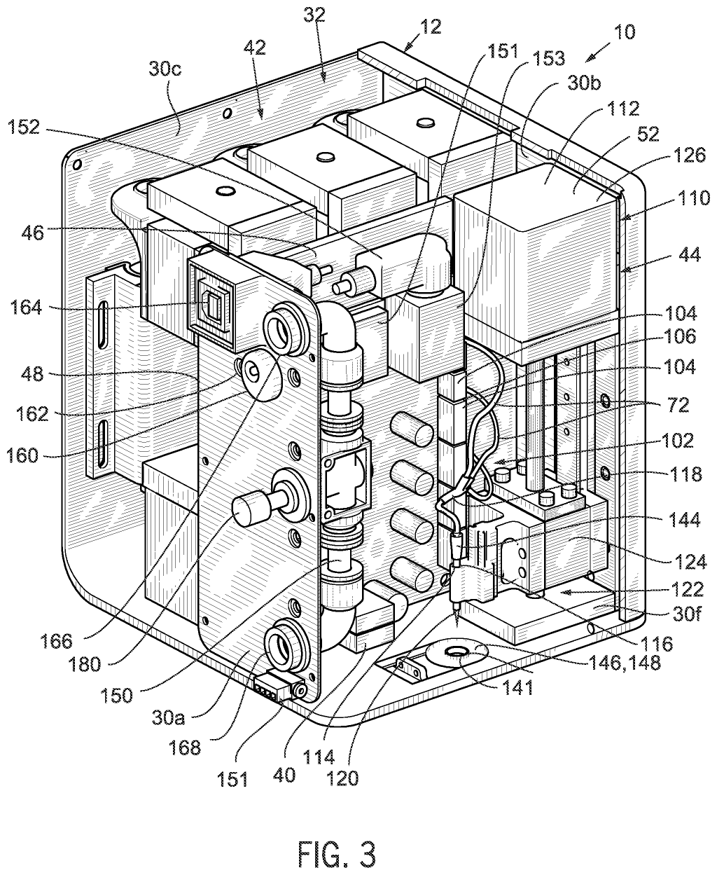

Referring now to FIGS. 2 and 3, the housing 12 of the pick and place device 10 has upstanding left and right outer sidewalls 30a and 30b and an upstanding outer front and rear walls 30c, 30d extending between and joining opposed, generally horizontal outer upper and lower walls 30e and 30f. The walls 30 may be insulated to prevent the transfer of heat to or from the fluids and/or microscopic objects 24 which may be temperature sensitive. The walls 30 enclose a volume 32 which supports a pump assembly 60 and needle assembly 110 described below.

As seen in FIG. 3, the volume 32 is separated by a dividing wall 40 (partially removed) which separates the volume 32 into a syringe compartment 42 and an electronics compartment 44, for example, separating the volume 32 into rear and front compartments, respectively. In this way, the fluids contained within the syringe compartment 42 are isolated from the electronics compartment 44 to prevent moisture from entering the electronics compartment 44. The dividing wall 40 may be insulated to provide a separation of different temperatures between the syringe compartment 42 and the electronics compartment 44. A temperature control element may be used to control the temperature of the compartments such as a resistive heater or a Peltier device providing desired heating or cooling. The dividing wall 40 may also support thereon certain electronic components to be described below.

An electronic control circuit 46 may be positioned within the electronics compartment 44 and may be supported by or on the dividing wall 40. The electronic control circuit 46 communicates with a control panel 48 of the housing 12 to receive operation instructions from a user and to provide control of a syringe motor 50, needle motor 52, and other electronic components to be described below. The electronic control circuit 46 may hold, for example, a microprocessor for executing a program held in a stored memory.

Referring now to FIG. 2, a pump assembly 60 may be positioned within the syringe compartment 42 communicating with the electronic control circuit 46 and the syringe motor 50 to communicate operation instructions from the user to coordinate syringe plunger movement of the pump assembly 60.

The pump assembly 60 comprises a set of syringe drivers 62, for example, three independently controlled syringe drivers, for linear movement of a plunger portion of syringe barrels or tubes 64. Each syringe tube 64 has a first open end 66 receiving a plunger 68. A first end 66 of the plunger 68 within the syringe tube 64 is connected to a piston seal (for example, of an elastomeric material) fitting snugly within the volume of the syringe tube 64. A second end 70 of the syringe tube 64, opposite the open first end 66, connects to fluidic tubing 72, for example, a bevel tip connected by an external luer connector 74 or the like, to provide a continuous passageway between the volume 76 contained between the piston seal and the luer connector 74 of the fluidic tubing 72. In certain embodiments, the syringe tube 64 may hold between 5 μL to 500 μL of fluid and the syringe tube 64 diameter may vary between volumes. The volume of fluid may be fluids holding cells, biofluids, drug compounds, etc.

A distal end 69 of the plunger 68 extending away from the piston seal and out of the syringe tube 64 may be connected to one of the syringe drivers 62. Each syringe driver 62 includes a plunger bracket 80 constrained for linear movement along an axis of the syringe tube 64 as driven by the syringe motor 50. The syringe motor 50 may be, for example, a stepper motor, servomotor, or the like and may include an appropriate mechanism for speed reduction and conversion of rotary to linear motion, such as may be implemented by a linear screw, rack and pinion, belt drive or the like. The syringe motor 50 receives power from a syringe motor controller 82 to provide movement of the plunger bracket 80 to move the piston seal through the volume of the syringe tube 64 at a controlled rate and controlled distance. As understood in the art, the movement of the plunger 68 dispenses or suctions precise and controlled amounts of liquid (in the order of picolitres) through the connected fluidic tubing 72 by creating a positive or negative pressure within the syringe tube 64, and further through the connected fluidic tubing 72.

Various position or velocity sensors such as encoders, tachometers, limit switches, and the like may be used to communicate with the syringe motor controller 82 as is understood in the art to provide such controlled motion. In addition, the sensors can provide a first estimate of a flow of medicament from the syringe based on known dimensions of the syringe tube 64.

The pump assembly 60 may provide, for example, a pump housing 61 supporting a side by side configuration of the set of syringe drivers 62 and further removably receiving a cradle 84 receiving the bodies of the syringe tubes 64. The removable cradle 84 provides a front wall 85 with a set of generally forwardly open channels to receive each of the syringe tubes 64 in a direction perpendicular to the axis of the syringe tubes 64 to allow a newly filled syringe tube 64 to be easily inserted into the cradle 84. In the embodiment shown, the removable cradle 84 supports three syringe tubes 64 which are moved by three corresponding syringe drivers 62.

Various barrel sizes of syringe tubes 64 may be loaded into the cradle 84 with the assistance of channel brackets for each syringe tube 64, each providing a cylindrical shroud 65 with laterally extending flanges 88 flanking a forwardly open channel receiving the bodies of the syringe tubes 64 and fastened therein by compression bars 67 extending across the open channel and attached to the laterally extending flanges 88, for example, by fasteners. The cylinder shrouds 65 may have various inner diameters in order to support differently sized diameter syringe tubes 64. For example, the cylinder shrouds 65 may be sized to wrap around barrels of syringe tubes 64 with outer diameters which range from 5 mm to 500 mm and the compression bars 67 retain the barrels within the cylinder shrouds 65 regardless of diameter.

The cylindrical shroud 65 may be snapped into the forwardly open channels of the removable cradle 84. The outwardly extending flanges 88 receive fasteners in a direction perpendicular to the axis of the syringe tubes 64 to fix the cylindrical shroud 65 to the front wall 85 of the removable cradle 84. The compression bars 67 may receive the same fasteners to fix the compression bars 67 and the cylindrical shroud 65 to the front wall 85 of the removable cradle 84.

The pump housing 61 receives the removable cradle 84 so that the plunger brackets 80 engage the distal ends 69 of the plungers 68 and so that the plungers 68 move with the plunger brackets 80. The plunger brackets 80 may each provide a forwardly extending overhang 90 with an oblong indentation on a lower surface receiving a similarly shaped oblong distal end 69 of the plunger 68. A hole 91 within the forwardly extending overhang 90 may receive a fastener extending into a threaded hole of the distal end 69 of the plunger 68 permitting a secure coupling between the forwardly extending overhang 90 and the distal end 69 of the plunger 68 for corresponding movement.

The removable cradle 84 may be further secured within the housing 12 and to provide a fixed position and communication with the plunger brackets 80, for example, by fastening the outer lateral ends 92, 94 of the cradle 84 to inner surfaces of left and right outer sidewalls 30a and 30b which may include corresponding attachment brackets 96. The pump housing 61 of the pump assembly 60 may be further secured within the housing 12, for example, by fastening the pump housing 61 to the dividing wall 40 and the upper wall 30e and using a guardrail 97 across the left and right outer sidewalls 30a and 30b to hold the pump housing 61 against the dividing wall 40.

The rear wall 30d enclosing the rear opening of the syringe compartment 42 may hold at least one window 100 providing a single opening or separate openings which are positioned in front of each syringe tubes 64 to allow the user to see the syringe tubes 64 from outside the housing 12 to provide a visual indication of, e.g., how many syringe tubes 64 are loaded and to visually estimate the amount of volume remaining within the syringe tubes 64 or if the syringe tubes 64 are empty.

Referring now to FIG. 3, the fluidic tubing 72 may be pre-attached to the syringe tubes 64 and may pass through an opening or holes 102 in the dividing wall 40 allowing the fluidic tubing 72 to pass from the syringe compartment 42 into the electronics compartment 44. The dividing wall 40 may support a tubing collector 104 which provides parallel horizontal channels 106 receiving the multiple fluidic tubing 72 from the syringe tubes 64 in order to gather and organize the fluidic tubing 72 for further distribution to a needle 114 without placing unwanted force or tension on the needle 114 as further described below.

A needle assembly 110 may be positioned within the electronics compartment 44 communicating with the electronic control circuit 46 and the needle motor 52 to communicate operation instructions from the user to coordinate needle movement of the needle assembly 110.

The needle assembly 110 comprises a needle driver 112 for linear movement of a needle 114. The needle 114 has a first open end 116 connected to the fluidic tubing 72 of the syringe tubes 64. The needle 114 may fluidly communicate with the fluidic tubing 72 of all syringe tubes held within the housing 12 by, for example, a three-way diverter connector 118 connecting the three fluidic tubing 72 from the syringe tubes 64 to a single fluidic tubing 72, a multi-channel needle receiving fluid for each of the three fluidic tubing 72, a microfluidic chip receiving fluid for each of the three fluidic tubing 72, and the like. A second end 120 of the needle 114, opposite the first open end 116, provides a continuous passageway to the translating stage 22 for pick and place and 3D bioprinting operations. In one embodiment of the present invention, the needle 114 may be an 18-gauge needle.

The needle 114 may be connected to the needle driver 112 through a needle mount 122 attached to a plunger bracket 124 constrained for linear movement along an axis of the needle 114 as driven by the needle motor 52. The needle motor 52 may be, for example, a stepper motor or servomotor or the like and include an appropriate mechanism for speed reduction and conversion of rotary to linear motion, such as may be implemented by a linear screw, rack and pinion, belt drive or the like. The needle motor 52 receives power from a needle controller 126 to provide vertical movement of the plunger bracket 124 to move the needle 114 at a controlled rate and controlled distance. Various position or velocity sensors such as encoders, tachometers, limit switches, and the like may be used to communicate with the needle controller 126 as is understood in the art to provide such controlled motion. In addition, the sensors can provide a vertical position of the second end 120 of the needle 114 based on a known length of the needle 114 and position of the needle tip.

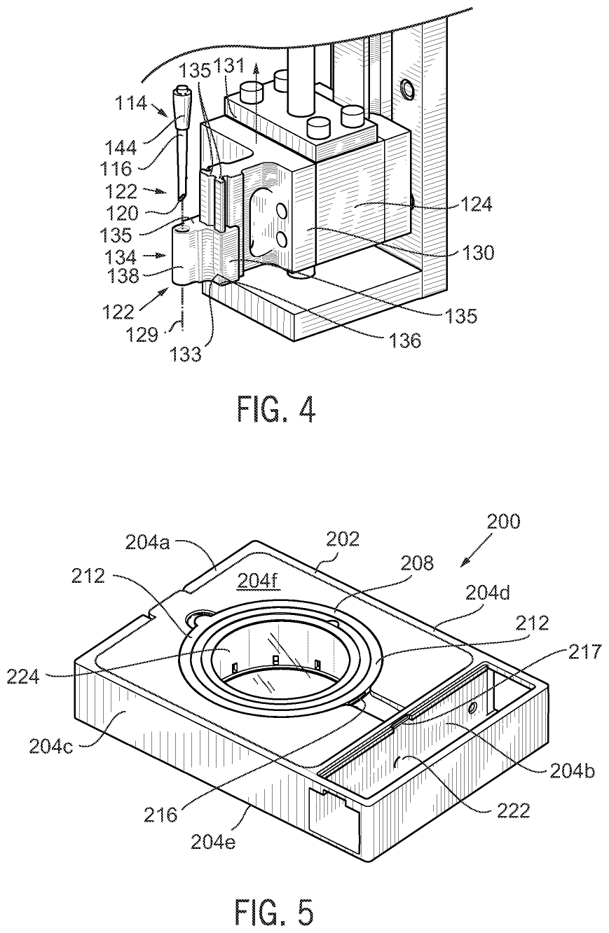

Referring also to FIG. 4, the needle mount 122 includes a rail mount 130 mounted to an outer wall 131 of the plunger bracket 124 to move along with the plunger bracket 124 along an axis 129 (z axis) of the needle 114 and supporting vertical rails 132 forming a track slidably receiving a collar 133 of a slide block 134. The collar 133 slidably fits over the vertical rails 132 and is constrained for linear movement along a length of the vertical rail 132 by opposed rolled edges 135 of the collar 133 retaining the slide block 134 on the vertical rails 132.

A bottom end of the vertical rails 132 have stop blocks 136, for example, stop blocks positioned on the sliding path of the slide block 134, to contact the slide block 134 preventing further downward movement of the slide block 134 and specifically positioned to prevent the slide block 134 from being removed from the bottom end of the vertical rail 132. Therefore, in a neutral position, slide block 134 is positioned at the bottom end of the vertical rails 132 due to gravitational force and rests upon the stop blocks 136 of the vertical rails 132. The collar 133 of the slide block 134 may contain inner ball or roller bearings which reduce friction and assist with linear sliding movement of the slide block 134 along the rails 132.

The vertically translating slide block 134 further supports a needle holder 138 with a tubular collar supporting a channel extending along the axis 129 of the needle 114 and retaining or clamping the needle 114 or needle hub 144 of the needle 114 in a fixed vertical position along the axis 129. The needle 114 may be held within the needle holder 138 to provide a predetermined downward extension of the needle 114 of a known distance.

The needle holder 138 provides a vertical alignment of the needle 114 with a needle orifice 140 of the horizontal outer lower wall 30f allowing the needle 114 to extend through the needle orifice 140 along the axis of the needle 114 when the plunger bracket 124 is vertically translated. The axis of the needle 114 is aligned with the objective lens 26 below the translating stage 22. The needle orifice 140 may be formed within the horizontal outer lower wall 30f and may include an upwardly extending gasket 141 receiving the needle holder 138 thereagainst.

The needle mount 122 provides a vertical sliding configuration such that when the second end 120 of the needle 114 is lowered too low by the plunger bracket 124 thus contacting the translating stage 22 to create an upward force on the needle 114, the slide block 134 will automatically retract or slide upward along the vertical rail 132 to prevent damage to the needle 114, translating stage 22, and/or other apparatus positioned on the translating stage 22. In this respect, the needle mount 122 provides a “fail-safe” design to minimize accidental damage by the needle 114.

The needle orifice 140 may support a light ring 146 which is a repositioned light source, e.g., light emitting diodes (LEDs) and the like, which directs illumination downwards through a light diffuser 148 surrounding the needle orifice 140 to disperse the light downward toward the translating stage 22 holding the microscopic objects 24 positioned below the horizontal outer lower wall 30f. In this manner, the light source 18 of a conventional inverted microscope is not used and the repositioned light source of the pick and place device 10 is moved to the bottom of the housing 12 so that the light may be directed through the magnified microscopic objects 24 and clearly seen through the objective lens 26. In certain embodiments, the light ring 146 may use the 5 volt power source that is normally used by a controller by converting the DC voltage to 12 volt.

The needle assembly 110 may be further secured within the housing 12, for example, by fastening the needle driver 112 to one of the left and right outer sidewalls 30a and 30b. Other elements that may be supported within the electronics compartment 44 include a wireless transceiver 151, battery 152, data storage device 153, heating/cooling Peltier system, and elements for exterior devices, such as a pneumatic valve assembly 150, and the like.

As seen in FIG. 1, the front wall 30c enclosing the front opening of the electronics compartment 44 may hold at least one window 142 providing an opening positioned in front of the needle mount 122 to allow the user to see the needle mount 122 from outside the housing 12 and to provide a visual indication of the vertical position of the needle 114. The window 142 may also permit the user to change the needle 114 through the window 142 without removing the front wall 30c.

Referring to FIG. 3, the control panel 48 of the housing 12 may be mounted on an outer surface of or integrated with one of the left and right outer sidewalls 30a and 30b. The control panel 48 may have a power switch or button 160 for turning the device on and off, a reset button 162 for rebooting the device, a USB connector 164 allowing connection of external devices or storage devices, a “power in” connector 166, a “power out” connector 168, and other power or communication connectors for auxiliary or external devices such as sensor connectors 149. It is understood that the control panel 48 may also be repositioned or may relocate certain buttons or connectors to the front and rear sidewalls 30c, 30d for more convenient access to the user.

Referring to FIGS. 1 and 2, the horizontal outer upper wall 30e may support a raised disk 170 permitting the housing 12 to be held by the condenser mount 20. The condenser mount 20 of the inverted microscope 14 may include a support ring 172 or partial ring formed by inwardly facing curved arms receiving the raised disk 170 therein (instead of the condenser), for example, by unscrewing the raised disk 170 from the horizontal outer upper wall 30e, positioning the raised disk 170 above the support ring 172, and re-screwing the raised disk 170 into the horizontal outer upper wall 30e so that the raised disk 170 extends through the support ring 172 to support the housing 12 over the translating stage 22. In this respect, the housing 12 is suspended above the translating stage 22 and it is contemplated that the housing 12 may be suspended by other methods which utilize the support structure of the inverted microscope 14.

The electronic control circuit 46 will also provide the ability to receive inputs from a user control device 180 such as from a remote control, keyboard, voice assistant, or the like, for communication back to the syringe motor 50, needle motor 52, and a motor of the translating stage 22 of the inverted microscope 14. For example, the user control device 180 will control a flow rate of the pump assembly 60 by controlling the syringe motor 50, a vertical position of the needle 114 by controlling the needle motor 52, or a horizontal position of the translating stage 22 by controlling the motor of the translating stage 22. In one embodiment of the present invention, the user control device 180 may be a video game controller or a joystick. Machine learning and artificial intelligence techniques may be utilized to assist with control.

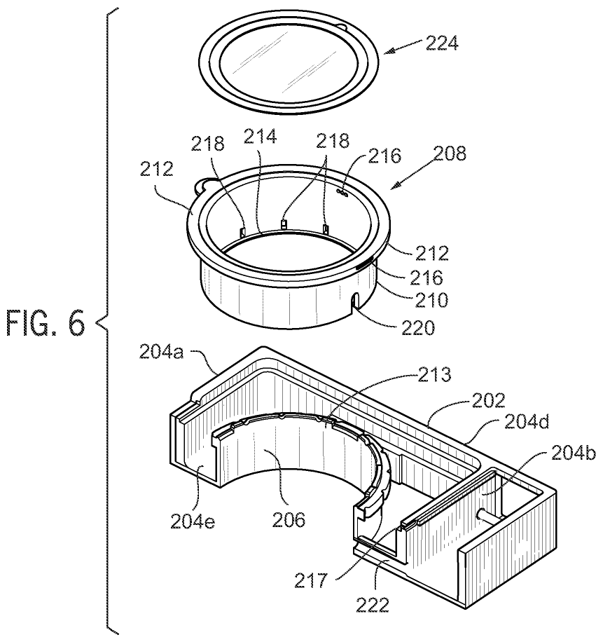

Referring to FIGS. 5 and 6, in one exemplary embodiment, an auxiliary or external device that may be used with the present invention is a cell incubator 200 that holds the microscopic objects 24 beneath the housing 12 of the pick and place device 10 and facilitates prolonged cell culture. The incubator 200 is in compliance with a standard 96-well plate format, rendering it compatible with all commercially available microscope adaptors. The incubator may be positioned on the translating stage 22 below the housing 12 to allow the needle 114 to, e.g., pick up cell cultures within a petri dish supported by the incubator 200.

The incubator 200 may include a cassette 202 having upstanding left and right sidewalls 204a and 204b and upstanding front and rear sidewalls 204c, 204d extending around a generally horizontal lower wall 204e and supporting thereon an upwardly extending cylindrical support frame 206 receiving a removable chamber 208 therein. An upper wall 204f may extend generally horizontally to enclose an upper opening surrounding the cylindrical support frame 206. The walls 204 may be insulated by insulation to prevent the transfer of heat to or from the microscopic objects 24 which may be temperature sensitive.

The cylindrical support frame 206 supports the removable chamber 208, the removable chamber 208 having a cylindrical body 210 with an outwardly extending upper rim 212 supported on a top edge 213 of the cylindrical support frame 206. The top edge 213 of the cylindrical support frame 206 may include notches or indentations which allow humidified airflow of any gas mixture created by pumping said gas mixture through an air tube with fine holes creating a large number of small bubbles that travel through the heated water in the main chamber. These small bubbles pop on the surface and carry heated water molecules into the air. This mixture of gas and water travels through the notches of cylindrical support frame 206 to ensure any cells at the bottom of removable chamber 208 are in an environment with desired gas mixture at the desired temperature and at high humidity which lessens the dehydration of samples when the outwardly extending upper rim 212 of the removable chamber 208 is supported on the top edge 213 of the cylindrical support frame 206.

The cylindrical body 210 of the removable chamber 208 may support tubing ports 216 on a top edge for receiving microfluidic tubing into the interior of the cylindrical body 210 and allowing incubator gas to flow in and out. The cassette 202 may include a channel 217 permitting the microfluidic tubing to pass through an outer wall of the cassette 202 and into the tubing ports 216.

The cylindrical body 210 also has an inwardly extending petri dish lip 214 on a bottom edge for receiving a petri dish thereon, for example, a 50 mm glass slide or petri dish adaptor further supporting a bottom wall of a petri dish. The cylindrical body 210 may support air flow ports 218 on a bottom edge for permitting air or gas circulation into an interior of the cylindrical body 210 and a temperature probe hole 220 on a bottom edge for receiving a temperature probe. The cassette 202 may include a channel 222 permitting the temperature probe to pass through an outer wall of the cassette 202 and into the temperature probe hole 220.

An inner cover 224 may extend generally horizontally over and enclose an upper circular opening of the cylindrical body 210 of the removable chamber 208 providing a transparent viewing pane to see into the interior of the cylindrical body 210 and sealing the interior of the cylindrical body 210 so that it may sealingly retain the incubator gas therein.

In operation, the cell incubator 200 may be held beneath the housing 12 of the pick and place device 10 and support the microscopic objects 24. The user may operate the user control device 180 to control a vertical position (z position) of the needle 114 by controlling the needle motor 52, and a horizontal x, y position of the translating stage 22 by controlling the motor of the translating stage 22. It is understood that wireless remote control of the translating stage 22 may utilize the stage motor and stage controller associated with the inverted microscope 14 such that the structure and functions of the inverted microscope 14 are utilized.

The user may observe the microscopic objects 24 by looking through the eyepiece 28 and therefore are able to see a position of the needle 114 with respect to the microscopic objects 24 and adjust the vertical position (z position) of the needle and/or horizontal x, y position of the microscopic objects 24 accordingly. The precise positioning may be in the order of microns. It is understood that the objective lens 26 and eyepiece 28 associated with the inverted microscope 14 are utilized with the pick and place device 10 such that the structure and functions of the inverted microscope 14 are utilized.

The user may further operate the user control device 180 to control the syringe motors 50 in order to perform pick and place operations necessary, for example, for pick and place (e.g., chip platforms, gradient studies, etc.), 3D bioprinting, and micromanipulation processes. The operation of the syringe motors 50 of the pump assembly 60 may be used to control the hold, suction, and discharge of small volumes (in the order of picolitres) of fluid holding the microscopic objects 24.

In one embodiment, the microscopic object 24 may be picked up by the needle 114, e.g., within a droplet, by creating a negative pressure (suction) within the syringe tube 64, fluidic tubing 72, needle 114 and move the needle 114 to a target position by manipulating the needle 114 and translating stage 22 position while the pressure within the pump assembly 60, fluidic tubing 72, needle 114 is held constant (hold). The microscopic object 24 may be placed at the target position by releasing the negative pressure (discharge) within the syringe tube 64, fluidic tubing 72, needle 114. The placement of the microscopic object 24 may also depend on the capillary forces of the droplet holding the microscopic objects 24.

The term “pick and place” is used herein to refer generally to picking up and/or placing operations of microscopic objects that may be used, for example, for pick and place (e.g., chip platforms, gradient studies, etc.), 3D bioprinting, micromanipulation processes and the like and is not intended to be limited to pick and place only.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “controller” and “a processor” should be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An apparatus for manipulating microscopic objects with an inverted microscope having a stage positioned above an objective lens for supporting the microscopic objects, comprising:
a housing having at least one support adapted to attach to the inverted microscope;
a needle holder attachable to the housing permitting a needle to move along at least one axis;
an orifice extending through the housing permitting the needle to move therethrough and position the needle above the stage and objective lens of the inverted microscope; and
a pump assembly attachable to the housing and operating to communicate with the needle to permit fluid flow through the needle.

2. The apparatus of claim 1 wherein the at least one support is adapted to attach to a condenser mount of the inverted microscope and configured to suspend the housing above the stage.

3. The apparatus of claim 2 wherein the at least one support is an upwardly extending removable disk receivable by the condenser mount to permit the condenser mount to hold the removable disk.

4. The apparatus of claim 1 further comprising a light source attachable to the housing and configured to direct light below the housing and toward the stage.

5. The apparatus of claim 4 further comprising a light diffuser surrounding the orifice and positioned below the light source.

6. The apparatus of claim 1 wherein the pump assembly comprises at least one syringe pump having a motor unit attachable to the housing and including an electrical motor and driver to move a plunger of the syringe pump and connectable to fluidic tubing fluidly communicating with the needle.

7. The apparatus of claim 6 further comprising a controller executing a stored program stored in memory and communicating with the electrical motor of the pump assembly to control movement of the plunger based on a command signal.

8. The apparatus of claim 7 wherein the pump assembly comprises at least three syringe pumps.

9. The apparatus of claim 7 wherein the pump assembly comprises a removable cradle attachable to the housing receiving at least one syringe tube of the at least one syringe pumps.

10. The apparatus of claim 7 further comprising a tube collector attachable to the housing and providing parallel channels receiving the fluidic tubing.

11. The apparatus of claim 1 wherein the needle holder comprises a motor unit attachable to the housing and including an electrical motor and driver to move a needle mounting bracket along the axis based on a command signal.

12. The apparatus of claim 11 further comprising a controller executing a stored program stored in memory and communicating with the electrical motor of the needle holder to control movement of the needle mounting bracket based on a command signal.

13. The apparatus of claim 11 wherein the needle holder comprises a tubular collar coupled to the needle mounting bracket and configured to retain the needle therein.

14. The apparatus of claim 13 wherein the tube collar is slidable along the axis with respect to the needle mounting bracket and independent of the movement of the needle mounting bracket.

15. A method of manipulating microscopic objects with an inverted microscope having a stage positioned above an objective lens for supporting the microscopic objects, comprising:
providing a housing having at least one support adapted to attach to the inverted microscope, a needle holder attachable to the housing permitting a needle to move along at least one axis, an orifice extending through the housing and permitting the needle to move therethrough, and a pump assembly attachable to the housing and operating to communicate with the needle to permit fluid flow through the needle;
attaching the at least one support of the housing to an inverted microscope to suspend the housing above the stage;
installing a needle within the needle holder;
moving the needle holder and needle along the axis to extend the needle through the orifice; and
manipulating microscopic objects supported on the stage via fluid flow through the needle.

16. The method of claim 15 further comprising directing light toward the stage.

17. The method of claim 15 wherein the pump assembly comprises at least one syringe pump having a motor unit attachable to the housing and including an electrical motor and driver to move a plunger of the syringe pump and connectable to fluidic tubing fluidly communicating with the needle.

18. The method of claim 17 further comprising controlling movement of the plunger based on a command signal.

19. The method of claim 15 wherein the needle holder comprises a motor unit attachable to the housing and including an electrical motor and driver to move a needle mounting bracket along the axis based on a command signal.

20. The method of claim 19 further comprising controlling movement of the needle mounting bracket along the axis based on a command signal.
